(19) United States
(12) Patent Application Publication
(10) Pub. No.: US 2023/0097213 A1
(43) Pub. Date: Mar. 30, 2023

(54) CASH DISCOUNT PROGRAM FOR CLOUD-BASED POINT OF SALE SYSTEM

(71) Applicant: Lavu, Inc., Albuquerque, NM (US)

(72) Inventors: Saleem S. Khatri, Tampa, FL (US); Udayakumar Subbarayan, Sunnyvale, CA (US); Abduraheem Poonthiruthi, Bangalore (IN); Parasmal Praveen Jain, Hyderabad (IN); Yulia Acquatella, Miami, FL (US); Michael Ream McCabe, Albuquerque, NM (US)

(73) Assignee: Lavu, Inc., Albuquerque, NM (US)

(21) Appl. No.: 17/932,865

(22) Filed: Sep. 16, 2022

Related U.S. Application Data
(60) Provisional application No. 63/355,517, filed on Jun. 24, 2022.
(60) Provisional application No. 63/297,064, filed on Jan. 6, 2022.
(60) Provisional application No. 63/289,063, filed on Dec. 13, 2021.
(60) Provisional application No. 63/248,898, filed on Sep. 27, 2021.

(51) Int. Cl. G06Q 30/02; G06Q 20/20; G06Q 20/22

(52) U.S. Cl. CPC G06Q 30/0238; G06Q 20/209; G06Q 20/227; G06Q 20/203

(57) ABSTRACT

A point of sale system includes a payment module having a plurality of payment modes, and a discount module configured to determine a discount associated with each of the plurality of payment modes. The point of sale system includes a processor configured to receive a request for processing the payment for the purchase order, and generate at least one first invoice receipt for the purchase order. The at least one first invoice receipt includes an indication of the discount available corresponding to each of the plurality of payment modes. The processor is also configured to process the payment of the purchase order using a desired payment mode of a customer and generate at least one final invoice receipt indicating the desired payment mode and the discount associated with the desired payment mode.

### CROSS-REFERENCE TO RELATED APPLICATIONS

This application claims priority to and the benefit of U.S. Provisional Patent Application No. 63/248,898 filed on Sep. 27, 2021; U.S. Provisional Patent Application No. 63/289,063 filed on Dec. 13, 2021; U.S. Provisional Patent Application No. 63/297,064 filed on Jan. 6, 2022; and U.S. Provisional Patent Application No. 63/355,517 filed on Jun. 24, 2021. The contents of each of these applications are hereby incorporated by reference herein for all purposes.

### TECHNICAL FIELD

This disclosure is generally directed to point of sale systems. More specifically, this disclosure is directed to a cash discount program for the point of sale system.

### BACKGROUND

Merchants that accept credit cards are usually charged a fee on the order of around three (3) percent. Over the past decade, merchants have seen an upward trend in such fees without any effective way of “fighting back” or resisting such fees. The merchant could choose to not accept credit cards; however, doing so could be detrimental to the merchant's business because many consumers preferred credit cards. To recover fees for such charges, a merchant can attempt to charge a card-processing “surcharge”; however, laws in multiple states prevent assessing “surcharges.” For the states that do not prevent such assessments, a local municipality may need to be consulted to ensure compliance. Also, there are often different limits that may be allowed for “surcharges.” And, the merchant is often required to notify card brands if they play on charging. For merchants that have presence in multiple cities and states, surcharge compliance can be difficult—in not prohibitive on the practice of surcharges.

### SUMMARY OF THE DISCLOSURE

According to an embodiment of the disclosure, a point of sale system and a method for providing a discount based on the payment mode at the point of sale system is provided.

A point of sale system is disclosed. The point of sale system includes a payment module having a plurality of payment modes for facilitating a payment for a purchase order for at least one item, and a discount module arranged in communication with the payment module and configured to determine a discount associated with each of the plurality of payment modes. The point of sale system includes a processor arranged in communication with the payment module and the discount module. The processor is configured to receive a request for processing the payment for the purchase order, and generate at least one first invoice receipt for the purchase order. The at least one first invoice receipt includes an indication of the discount available corresponding to each of the plurality of payment modes. The processor is also configured to process the payment of the purchase order using a desired payment mode of a customer and generate at least one final invoice receipt indicating the desired payment mode and the discount associated with the desired payment mode.

A method for transacting at a point of sale system is disclosed. The method includes receiving, by a processor, a request for processing a payment for a purchase order for at least one item, and determining, by the processor, a discount associated with each of a plurality of payment modes. The method also includes generating, by the processor, at least one first invoice receipt for the purchase order. The at least one first invoice receipt includes an indication of the discount available corresponding to each of the plurality of payment modes. Moreover, the method includes presenting the at least one first invoice receipt to a customer, and processing, by the processor, the payment of the purchase order using a desired payment mode of the customer and generating at least one final invoice receipt indicating the desired payment mode and the discount associated with the desired payment mode.

### BRIEF DESCRIPTION OF THE DRAWINGS

For a more complete understanding of this disclosure and its features, reference is now made to the following description, taken in conjunction with the accompanying drawings, in which:

FIG. 1 shows a block diagram of a point of sale system, according to an embodiment of the disclosure;

FIG. 2 shows a first invoice receipt depicting the discounts for each payment mode, according to an embodiment of the disclosure;

FIG. 3 shows a view of a user interface of the point of sale system, according to an embodiment of the disclosure;

FIG. 4 shows a final invoice receipt depicting the discount and the payment mode, according to an embodiment of the disclosure; and

FIG. 5 shows a method for performing a transaction at the point of sale system, according to an embodiment of the disclosure.

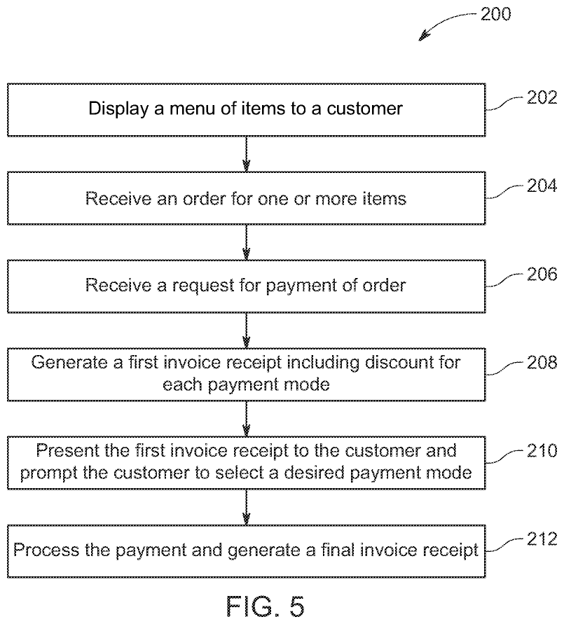

### DETAILED DESCRIPTION

Example embodiments are described below with reference to the accompanying drawings. Unless otherwise expressly stated in the drawings, the sizes, positions, etc., of components, features, elements, etc., as well as any distances therebetween, are not necessarily to scale, and may be disproportionate and/or exaggerated for clarity.

The terminology used herein is for the purpose of describing particular example embodiments only and is not intended to be limiting. As used herein, the singular forms “a,” “an” and “the” are intended to include the plural forms as well, unless the context clearly indicates otherwise. It should be recognized that the terms “comprise,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. Unless otherwise specified, a range of values, when recited, includes both the upper and lower limits of the range, as well as any sub-ranges therebetween. Unless indicated otherwise, terms such as “first,” “second,” etc., are only used to distinguish one element from another. For example, one element could be termed a “first element” and similarly, another element could be termed a “second element,” or vice versa. The section headings used herein are for organizational purposes only and are not to be construed as limiting the subject matter described.

Unless indicated otherwise, the terms “about,” “thereabout,” “substantially,” etc., mean that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art.

Spatially relative terms, such as “right,” left,” “below,” “beneath,” “lower,” “above,” and “upper,” and the like, may be used herein for ease of description to describe one element's or feature's relationship to another element or feature, as illustrated in the drawings. It should be recognized that the spatially relative terms are intended to encompass different orientations in addition to the orientation depicted in the figures. For example, if an object in the figures is turned over, elements described as “below” or “beneath” other elements or features would then be oriented “above” the other elements or features. Thus, the term “below” can, for example, encompass both an orientation of above and below. An object may be otherwise oriented (e.g., rotated 90 degrees or at other orientations) and the spatially relative descriptors used herein may be interpreted accordingly.

Unless clearly indicated otherwise, all connections and all operative connections may be direct or indirect. Similarly, unless clearly indicated otherwise, all connections and all operative connections may be rigid or non-rigid.

Like numbers refer to like elements throughout. Thus, the same or similar numbers may be described with reference to other drawings even if they are neither mentioned nor described in the corresponding drawing. Also, even elements that are not denoted by reference numbers may be described with reference to other drawings.

Many different forms and embodiments are possible without deviating from the spirit and teachings of this disclosure and so this disclosure should not be construed as limited to the example embodiments set forth herein. Rather, these example embodiments are provided so that this disclosure will be thorough and complete, and will convey the scope of the disclosure to those skilled in the art.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments.

Additionally, it should be understood that while certain advantages may be described with reference to certain embodiments, other embodiments may have some or none of such advantages.

The FIGURES described below, and the various embodiments used to describe the principles of the present disclosure in this patent document are by way of illustration only and should not be construed in any way to limit the scope of the disclosure. Those skilled in the art will understand that the principles of the present disclosure invention may be implemented in any type of suitably arranged device or system. Additionally, the drawings are not necessarily drawn to scale.

It will be understood that well known processes and components have not been described in detail and have been omitted for brevity. Although specific steps, structures and materials may have been described, the present disclosure may not be limited to these specifics, and others may be substituted as it is well understood by those skilled in the art, and various steps may not necessarily be performed in the sequences shown.

Additionally, although described in the context of oil and gas applications, other industrial processes can avail from the teachings of this disclosure.

Given the negative consequences of surcharges described above, embodiments of the disclosure provide a systematic way of providing cash discounts in point-of-sale systems (POS)—including existing pointof0sales systems. The Durbin Amendment allows businesses to offer discounts as an incentive for customers to pay by alternative methods. In particular, it is considered an “in-kind” incentive in compliance with Section (2)(A) of the Durbin Amendment, a provision of United States Federal Law, 15 U.S.C & 169o-2. A Cash Discount from the regular price in accordance with section (4)(c)(4) of the same document can be provided Cash discounts are not presently prohibited in any state—minimizing the need to figure out compliance. When such a cash discount program is implemented, a merchant simply hangs a sign indicating that a cash discount is available. And, in effect, many of the benefits of attempting to recover fees from use of credit cards.

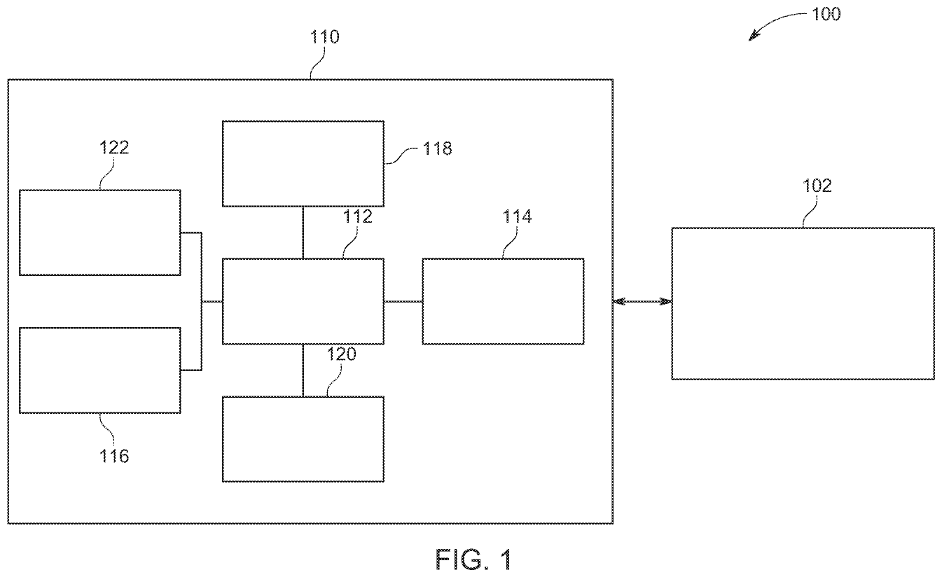

Referring to FIG. 1, a point-of-sale system 100 (hereinafter referred to as POS) is shown according to one embodiment of the disclosure. In an implementation, various sub-systems or the modules of the POS system 100 may be implemented using a server and may be accessed via a user device. In some embodiments, various sub-systems or the modules POS system may be implemented using a local computing device, for example, a tablet. The POS system 100 may include a user interface 102 (shown in FIG. 1) to facilitate a generation of at least an invoice for a purchase order and enables an interaction of a user, for example, a customer and/or a merchant, with the POS system. In an embodiment, the user interface 102 may be a graphical user interface to facilitate the user to interact with the POS system. In some embodiments, the user interface 102 may be a web-based application that can be accessed by a computing device, such as, but not limited to, a mobile phone, a desktop computer, a laptop, a tablet, or any other similar device that facilitates an access of the web-based application. The user interface 102 is in communication with a controller 110 of the POS system 100 to receive inputs from the user via the user interface 102, and process the inputs to generate the at least one invoice and process the payment corresponding the generated invoice for the purchase order.

In an embodiment, the controller 110 may include a processor 112, a menu module 114, a payment module 116, a price module 118, a discount module 120, and a customer database 122, etc. The processor 112 is arranged in communication with the menu module 114, the payment module 116, the price module 118, the discount module 120, and the customer database 122, and facilitates a generation of the invoice and processing of the payment based on inputs/selection received from the user through the user interface 102.

The menu module 114 is a database that includes a list of available items for sale. Further, each item is assigned a unique identifier to facilitate an easy access and retrieval of the item and corresponding price of the item. The menu module 114 may be accessed by the user via the user interface 102. In some embodiments, the items stored inside the menu module 114 may be arranged/stored/associated with a category, and all the items related to the category may be accessed via the user interface 102 upon selection of the category.

The price module 118 may include price corresponding to each of the item stored inside the menu module 114. Further, the price module 118 may be in communication with the payment module 116 and may determine a highest payment fee among the payment fees levied by various payment modes. Based on the highest payment fee, price for each item is determined. In an embodiment, the price for each item is calculated/determined by adding the highest payment fee to a basic price of the associated item.

The payment module 116 includes a list of a plurality of payment modes for making the payment for a purchase order, and facilitates payment of the purchase order through one or more of the payment modes. The plurality of payment modes includes a cash payment mode and at least one non-cash payment mode. Non limiting examples of the non-cash payment mode includes a credit card based payment mode, a debit card based mode of payment, a wallet based payment mode, a crypto based payment mode, etc. The user may access the payment module 116 via the user interface 102 and selects a desired payment mode. Further, the payment module 116 includes a payment fee associated with each mode of payment. Further, the payment module 116 is in communication with the discount module 120, and the discount module 120 is configured to access the payment fee for each payment mode and determines a discount corresponding to the associated payment mode.

The processor 112 is configured to display, via the user interface 102, various items available for purchase and associated price for each item to the user. The processor 112 is configured to display and provide access of the user interface 102 to the user upon receiving a request from the user to access the POS system 100. In an embodiment, the processor 112 may receive the request to access the POS system 100 when the user access a web based application stored in a user device or by accessing a website associated with the POS system 100 or POS system 100 installed on a local computing device, for example, a tablet. Further, the processor 112 is configured to receive inputs from the user and enables a selection, via the user interface 102, of one or more items available for purchase. It may be appreciated that the user interface 102 is configured to display a name of the item and associated price with the item. It may be appreciated that the processor 112 is configured to update the price of each item based on any changes in the highest fee being charged among the available payment modes.

Upon selection of the one or more items, the processor 112 is configured to determine if an input associated with initiating a payment for the selected items (i.e., the purchase order) is received. Upon receiving an input for initiating the payment for the purchase order, the processor 112 is adapted to initiate the payment of the ordered/selected items i.e., the purchase order. For so doing, the processor 112 is configured to generate a first invoice receipt 150 corresponding to the purchase order.

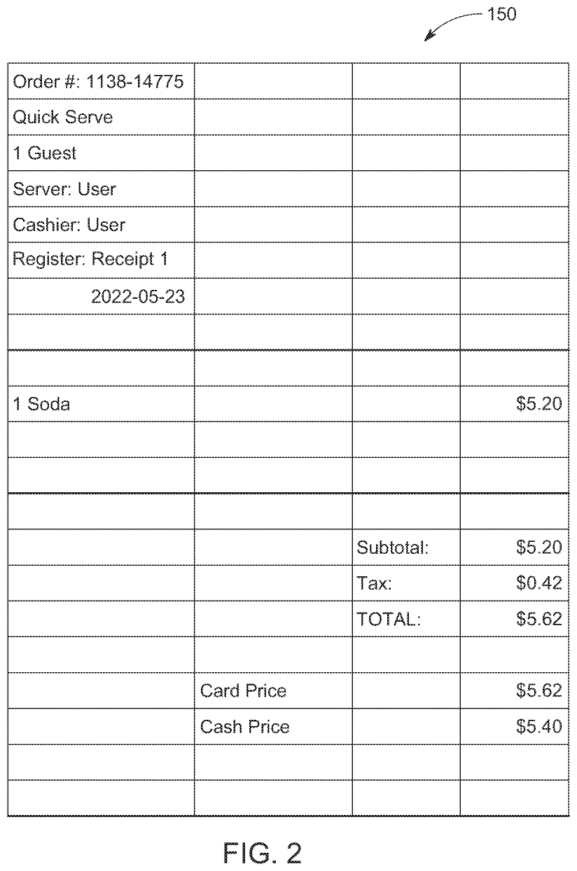

In an embodiment, the first invoice receipt 150 (shown in FIG. 2) includes a name of each ordered/purchased item and associated price of the item, the applicable tax, for example, sale tax, on the purchase of the ordered items, a total amount to be paid corresponding to the ordered items, and a discounted total amount corresponding to each payment mode. The processor 112 may be configured to display/show/share the first invoice receipt 150 to a customer/user. In an embodiment, the processor 112 may be configured to share the first invoice receipt 150 with the customer (i.e., the user) through the user interface 102. In some embodiments, the processor 112 may share a web based link to the user via a message, and the user can open and view the first invoice receipt 150 by accessing the web based link via the user device. In some embodiments, the processor 112 is configured to enable a physical print of the first invoice receipt 150 which can be shown to the customer by the merchant. Also, the processor 112 is configured to store the first invoice receipt 150 in the customer database 122 and associates the first invoice receipt 150 with the purchase order for later retrieval. It may be appreciated that the stored first invoice receipt 150 may be retrieved by using a number/identifier, for example, a purchase order number, associated with the purchase.

In some embodiments, the processor 112 is configured to determine if the customer is a recurring customer and may provide an additional discount depending upon the payment mode chosen/selected by the customer/user. For example, the processor 112 may calculate the discount applicable for each payment mode being equal to the fee associated with each payment mode upon determination that the customer is a recurring customer. Accordingly, the final price of the purchased items (i.e., purchase order) may be identical for each of the payment modes when the customer is a recurring customer.

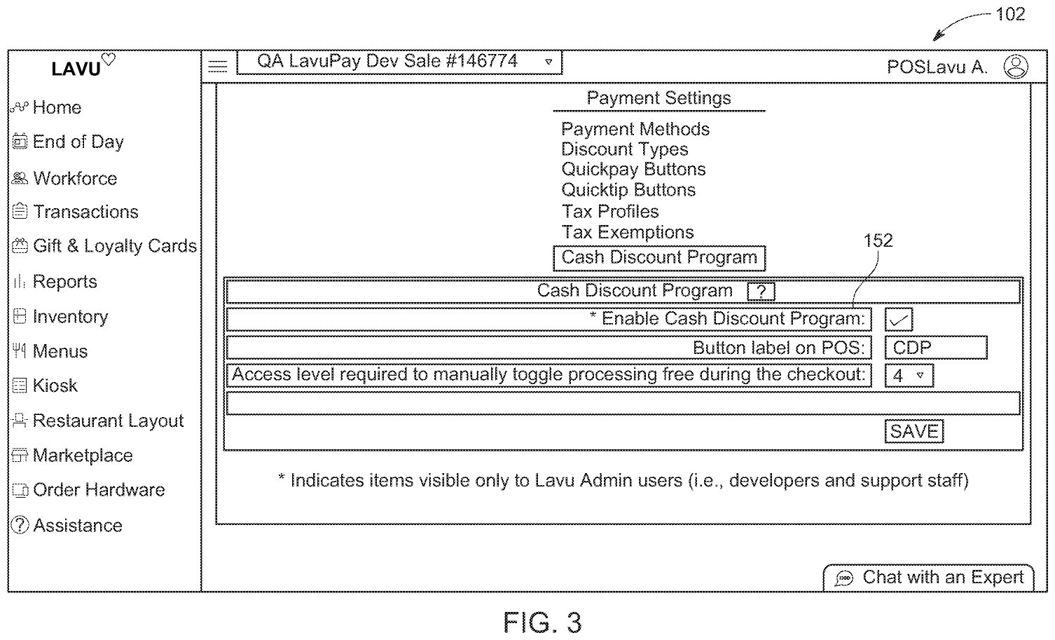

In some embodiments, the processor 112 may provide an option to enable or disable the discounts to be applied corresponding the payment mode. For so doing, the processor 112 may allow a selection by the merchant through the user interface 102 to select whether discounts corresponding the payment mode are applicable or not application. As shown in FIG. 3, the user interface 102 may provide a drop-down menu 152 and the merchant is able to select the desired option from the drop down menu. It may be appreciated that the processor 112 may include the discounts application to the payment modes only when the discount option is enabled.

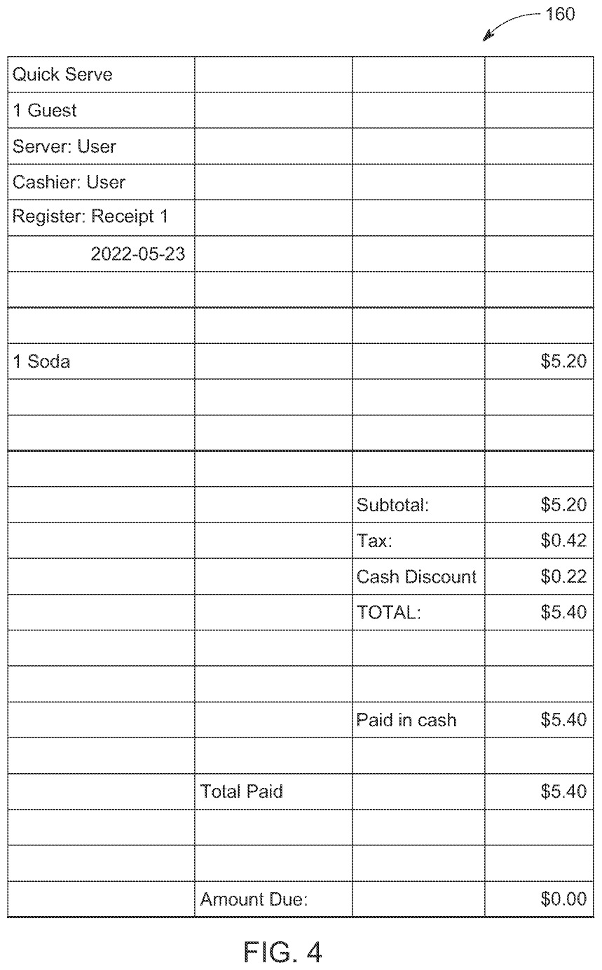

Based on the selection of the payment mode, the processor 112 is configured to process the payment and generate a final invoice receipt 160 (as shown in FIG. 4). The final invoice receipt 160 may include price for each item, the applicable tax, the mode of payment and the amount of discount, and the final amount paid by the customer/user. In this manner, the POS system 100 incentivize one payment mode over the other, reducing the overall fee paid to the payment provider. In some embodiments, the highest fee is charged by a credit card based payment mode and accordingly, the highest amount of discount is applied for a customer that selects the cash mode as the payment mode.

In an embodiment, the processor 112 may determine the selection of the desired payment mode based on the inputs received from the customer or merchant through the user interface 102. Alternatively, the processor 112 may detect/determined the desired mode of payment automatically. For example, the processor 112 may determine the desired payment mode as the credit card based payment mode when the processor detects/determine a swiping of a credit card. In some embodiments, the processor 112 may determine the payment mode as the wallet based payment mode when a QR code is scanned. In such a scenario, the processor 112 may determine the payment mode as cash based payment mode when automatic input is missing.

An example method 200 for providing a discount to a customer or carrying out a transaction is now disclosed with reference to processing a payment using the POS system 100 for a restaurant. The method 200 includes at step 202 of displaying a menu of the items to a customer. In an embodiment, the menu may be displayed to the customer via a suitable device, for example, the tablet, etc. In some embodiments, the customer accesses the menu by scanning a code, for example, a QR code, via a user device, for example, a mobile phone. Accordingly, the QR code enables an easy access of the menu or the user interface 102 of the POS system 100.

Thereafter, at a step 204 of the method 200, the customer selects one or more items from the menu and order the order the one or more items for delivery. In an embodiment, the customer may select the one or more items in the menu through the user interface 102 and may place the order through the user interface 102. In some embodiments, the customer may tell his choice of items to an assigned waiter (i.e., merchant) of the restaurant, and the waiter may input the selected items through a user device of the restaurant. Upon receipt of the inputs for the selected items, the processor 112 generates an order number and stores the information related to the order inside a database. In some embodiments, the processor 112 may prompt the user (i.e., the customer or the merchant), via the user interface 102, to input information related to the customer. For example, the processor 112 may prompt the user to input name of the customer, age of the customer, a phone number of the customer etc., to create or access a profile of the customer into the POS system 100. The processor 112 is configured to store the profile of a new customer containing the details inside the customer database 122. In an embodiment, the processor 112 may associate/relate/pair the order with the customer profile for lateral retrieval. Accordingly, the processor 112 may allow a user to access and view the details of the previous orders placed by the customer. Further, based on the customer profile and previous purchase history of the customer, the processor 112 may determine if the customer is repeat customer and assigns a loyalty benefit to the customer.

Further, the method 200 includes a step 206 for receiving a request for the payment corresponding to the purchase order from the customer. In an embodiment, the processor 112 may receive the request for payment through the user interface 102 accessed via the customer device or by entering the payment request through the device of the restaurant. Upon receiving the payment request, the processor 112, at a step 208 of the method 200, may access the discount module 120 and the payment module 116, and generates a first invoice receipt 150 corresponding to the purchase order number. In an embodiment, the waiter of the restaurant may input the order number via the user interface 102 to facilitate the generation of the first invoice receipt 150. In the illustrated embodiment, the POS system 100 (i.e., the payment module) may include two payment modes, a credit card based payment mode and a cash based payment mode. Accordingly, the processor 112 determines the discount corresponding to the cash based payment mode, and list the final price to be paid for each payment mode (as shown in FIG.). In some embodiments, before applying discounts corresponding to each payment mode, the processor 112 may determine if the discount option is enabled or disabled, and proceed to determine the discount and associated payable amount corresponding to each payment mode only when the discount option is enabled.

As shown in FIG. 2, the first invoice receipt 150 includes total price calculated based on the price for all the items, i.e., soda, and the applicable sale tax. Also, the first invoice receipt 150 includes a first payable amount corresponding to the credit card based payment mode and a second payable amount corresponding to the cash based payment mode. As can be seen from FIG. 2, the discount is provided only for the cash based payment mode, while the first payable amount is equal to the total price calculated without the discount. In some embodiments, before determining the discount applicable for each payment mode, the processor 112 may determine/check the customer profile and determine any loyalty benefit available for the customer, and calculates the payable amount for the purchase order based on the loyalty benefit. For example, in some embodiments, the first payable amount and the second payable amount may be equal based on the loyalty benefit available to the customer.

In some embodiments, the first payable amount may be reduced by deducting the discount available for the customer based on the loyalty benefit. In some embodiments, in addition to the payment mode and the loyalty benefit, the processor 112 may determine the discount based on total price of the order. For example, the processor 112 may also apply the discount to the credit card based payment mode when the total price before the discount is above a predefined value. For example, the processor 112 may apply to discount to the total price such that the first payable amount to be equal to the second payable amount when the total price is USD 100. Accordingly, the payable amount corresponding to each payment mode is equal when the total amount before discount is above the predefined value.

In an embodiment, the processor 112 may apply the discount to credit card based payment mode such that the total price before discount is below a predefined threshold. For example, the processor 112 may determine the first payable amount to be equal to the second payable amount when the total price is less than USD 2. Accordingly, the payable amount corresponding to each payment mode is equal when the final price before discount is below the predefined threshold.

The method 200, at step 210, also includes presenting the first invoice receipt 150 to the customer and prompting the customer to select the desired payment mode. In an embodiment, the processor 112 may present the first invoice receipt 150 via the user interface 102. In an embodiment, the processor 1012 may share/send a message or an email having a weblink/web address through which the customer can access the first invoice receipt 150 via the customer device, for example, mobile phone, tablet, or laptop. In some embodiments, the customer is able to select the desire payment mode through the user interface 102 accessed via the customer device. In some scenarios, the processor 112 may prompt the waiter (i.e., merchant) of the restaurant to physical print the first invoice receipt 150 and present the printed first invoice receipt to the customer. The waiter of the restaurant input the desired payment mode into the POS system 100 through the user interface 102 based on the input from the customer.

Upon receiving the input corresponding to the desired payment mode, the method 200 includes a step 212 in which the processor 112 processes the payment and generates the final invoice receipt 160. Upon receipt of the payment, the final invoice receipt 160 is shared with the customer in a manner similar to the sharing of the first invoice receipt 150 with the customer. Moreover, the processor 112 may save a copy of the final invoice receipt 160 into the customer database 122 and associate the final invoice receipt 160 with the order number and customer profile. In this manner, the POS system 100 provides differential pricing to the customer based on the payment mode and reduces the overall fee that need to be paid to the service providers of the various payment modes.

In some embodiment, POS system 100 may also allow to generate a plurality of first invoice receipts 150 and a plurality of final invoice receipts 160 for a purchase order to allow a splitting of the bill for a table at the restaurant/merchant. In an embodiment, the processor 112 may prompt the waiter or the customer to select to generate a single first invoice receipt 150 or a plurality of first invoice receipts 150 corresponding to the purchase order at the restaurant. Based on the selection of the plurality of the first invoice receipts 150, the processor 112 may ask a number of first invoice receipts 150 to be generated. For generating the plurality of first invoice receipts 150, the processor 112, in some embodiments, may divide the total amount of the purchase order into equal values and generates the first invoice receipts of the equal amounts. For example, when the single bill is to be divided into two, the processor 112 may divide the total amount into two equal halves and generates two first invoice receipts 150 corresponding to the purchase order. In such a case, in some embodiments, the processor 112 may determine the discount value corresponding to each of the payment mode to be zero.

In some embodiments, after dividing the total amount of the purchase order into various equal amounts for generating the plurality of first invoice receipts 150, the processor 112 may calculate the discount available for each payment mode and list the payable amount for each payment mode in each of the first invoice receipts 150 and share the first invoice receipts 150 with the customers associated with the purchase order. Thereafter, the processor 112 may process the payment corresponding to each first invoice receipt 150 separately based on desired payment mode for each first invoice receipt 150, and generates the final invoice receipt 160 corresponding to each first invoice receipt 150 as disclosed above with reference to a single final invoice receipt 160 for a purchase order.

In some embodiments, the processor 112 may process the split bill based on the items of the individual customer of the plurality of the customers. In such a case, the processor 112 may prompt the waiter (i.e., merchant) or one or more of the customers to input details associated with each customer as well the items purchased by each customer. Based on each customer detail and the associated purchased item(s), the processor 112 may generate a first invoice receipt 150 for each customer of the plurality of customers. In such a scenario, the processor 112 may treat each split of the purchase order as a separate order and generates the first invoice receipt 150 in a manner similar to the generation of first invoice receipt 150 for the individual order. Upon generating the first invoice receipt 150 for each customer, the processor 112 present the first invoice receipts 150 to plurality of customers, receives a selection of the desired payment mode corresponding to each first invoice receipt, process the payment and generate final invoice receipts 160 in a manner identical the processing and generation of the final invoice receipt 160 for a single purchase order as described above.

While this disclosure has described certain embodiments and generally associated methods, alterations, and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims. As a non-limiting example, while a particular application has been described, the described process may be used with other oilfield applications and industrial applications.

What is claimed is:

1. A point of sale system, comprising:
a payment module having a plurality of payment modes for facilitating a payment for a purchase order for at least one item;
a discount module arranged in communication with the payment module and configured to determine a discount associated with each of the plurality of payment modes; and
a processor arranged in communication with the payment module and the payment module and is configured to
receive a request for processing the payment for the purchase order,
generate at least one first invoice receipt for the purchase order, wherein the at least one first invoice receipt includes an indication of the discount available corresponding to each of the plurality of payment modes, and
process the payment of the purchase order using a desired payment mode of a customer and generate at least one final invoice receipt indicating the desired payment mode and the discount associated with the desired payment mode.

2. The point of sale system of claim 1 further including a user interface to facilitate an interaction of a user with the point of sale system.

3. The point of sale system of claim 1, wherein the processor is configured to determine the desired payment mode based on an input received from a user.

4. The point of sale system of claim 1 further including a price module having a price for each item available for sale, wherein the price for each item is determined based on a highest fee levied by a payment mode of the plurality of payment modes.

5. The point of sale system of claim 4, wherein
the plurality of payment modes includes a cash based payment mode and at least one non-cash based payment mode, and
the processor is configured to determine the price for each item based on the highest fee levied by the at least one non-cash based payment mode.

6. The point of sale system of claim 5, wherein the at least one non-cash based payment mode includes a credit card based payment mode.

7. The point of sale system of claim 1, wherein the processor is configured to determine the discount associated with each payment mode based on a customer profile.

8. The point of sale system of claim 1, wherein the processor is configured to determine the discount associated with each payment mode based on a total price of the purchase order.

9. The point of sale system of claim 1, wherein a user interface facilitates the user to selectively disable the discount for each payment mode, and the processor is configured to determine and apply the discount associated with the desired payment mode when the discount is enabled.

10. The point of sale system of claim 1 further including a menu module configured store a list of the item available for sale, and display the list of items via the user interface.

11. A method for transacting at a point of sale system, the method comprising:
receiving, by a processor, a request for processing a payment for a purchase order for at least one item;
determining, by the processor, a discount associated with each of a plurality of payment modes;
generating, by the processor, at least one first invoice receipt for the purchase order, wherein the at least one first invoice receipt includes an indication of the discount available corresponding to each of the plurality of payment modes;
presenting the at least one first invoice receipt to a customer; and
processing, by the processor, the payment of the purchase order using a desired payment mode of the customer and generating at least one final invoice receipt indicating the desired payment mode and the discount associated with the desired payment mode.

12. The method of claim 11 further including receiving, via a user interface, a selection of the at least one item from a user.

13. The method of claim 1, wherein the processor is configured to determine the desired payment mode based on an input received from a user.

14. The method of claim 11 further including determining a price for each item based on a highest fee levied by a payment mode of the plurality of payment modes.

15. The method of claim 14, wherein
the plurality of payment modes includes a cash based payment mode and at least one non-cash based payment mode, and
the price for each item is determined based on the highest fee levied by the at least one non-cash based payment mode.

16. The method of claim 15, wherein the at least one non-cash based payment mode includes a credit card based payment mode.

17. The method of claim 11, wherein the discount associated with each payment mode is determined based on a customer profile.

18. The method of claim 11, wherein the discount associated with each payment mode is determined based on a total price of the purchase order.

19. The method of claim 11, wherein a user interface facilitates the user to selectively disable the discount for each payment mode, and the processor is configured to determine and apply the discount associated with the desired payment mode when the discount is enabled.
